(19) United States
(12) Patent Application Publication
(10) Pub. No.: US 2025/0156718 A1
(43) Pub. Date: May 15, 2025

(54) TRAINING DEVICE, TRAINING METHOD, AND DEVICE AND METHOD OF DIAGNOSING ANOMALY OF EQUIPMENT USING SIGNAL RECONSTRUCTION MODEL

(71) Applicants: TECH UNIVERSITY OF KOREA INDUSTRY ACADEMIC COOPERATION FOUNDATION, Gyeonggi-do (KR); RESHENIE CORP., Gyeonggi-do (KR)

(72) Inventors: Yong Kwan LEE, Gyeonggi-do (KR); Ki Chang PARK, Gyeonggi-do (KR)

(21) Appl. No.: 18/946,191

(22) Filed: Nov. 13, 2024

Related U.S. Application Data
(63) Continuation of application No. PCT/KR23/21199, filed on Dec. 21, 2023.

(30) Foreign Application Priority Data
Nov. 9, 2023 (KR) 10-2023-0154842

(51) Int. Cl. G06N 3/088; G01N 29/12; G01N 29/44

(52) U.S. Cl. CPC G06N 3/088; G01N 29/12; G01N 29/4427; G01N 29/4454

(57) ABSTRACT

A training device, a training method, a failure diagnosis device, and a failure diagnosis method for diagnosing an anomaly of equipment using a signal reconstruction model are disclosed. The training device includes a memory configured to store instructions executable by a processor, and a processor, wherein the processor is configured to obtain a vibration frequency signal that measures vibration occurring when equipment is normally operated through a vibration sensor, train a signal reconstruction model configured to generate a reconstructed signal corresponding to the vibration frequency signal based on the obtained vibration frequency signal, obtain a reconstructed signal corresponding to the vibration frequency signal through the trained signal reconstruction model, determine a reconstruction error value representing a difference between the vibration frequency signal and the reconstructed signal, and determine a threshold value for the reconstruction error value for each of a plurality of predefined frequency bands.

### CROSS-REFERENCE TO RELATED APPLICATION(S)

This application is a continuation application, claiming priority under § 365 (c), of International Application No. PCT/KR2023/021199, filed on Dec. 21, 2023, which is based on and claims the benefit of Korean Patent Application No. 10-2023-0154842, filed on Nov. 9, 2023, in the Korean Intellectual Property Office, the disclosure of which is incorporated by reference herein in its entirety.

### BACKGROUND

### 1. Field

The following disclosure relates to a training device, a training method, a failure diagnosis device, and a failure diagnosis method for diagnosing an anomaly of equipment using a signal reconstruction model.

### 2. Description of Related Art

An equipment failure diagnosis technique using vibration of the equipment is a technique for diagnosing an anomaly of the equipment by analyzing a vibration frequency signal measured in the equipment. An unsupervised learning artificial intelligence (AI) model may be used to diagnose a failure of the equipment using the vibration of the equipment. The unsupervised learning AI model may be trained using a large volume of vibration data collected while the equipment is in a normal operation state. The equipment failure diagnosis technique using the unsupervised learning AI model may diagnose an anomaly of the equipment for all domains of measured vibration frequency signals.

### SUMMARY

In accordance with an aspect of the disclosure, a training device includes a memory configured to store instructions executable by a processor, and a processor, wherein the processor is configured to obtain a vibration frequency signal that measures vibration occurring when equipment is normally operated through a vibration sensor, train a signal reconstruction model configured to generate a reconstructed signal corresponding to the vibration frequency signal based on the obtained vibration frequency signal, obtain a reconstructed signal corresponding to the vibration frequency signal through the trained signal reconstruction model, determine a reconstruction error value representing a difference between the vibration frequency signal and the reconstructed signal, and determine a threshold value for the reconstruction error value for each of a plurality of predefined frequency bands.

The signal reconstruction model includes at least one of an autoencoder, a stacked autoencoder, a long short-term memory (LSTM) autoencoder, and a convolutional autoencoder model.

The processor is further configured to determine the reconstruction error value based on at least one of an average of differences between the vibration frequency signal and the reconstructed signal, an average of a square of the differences, and a square root of the average of the square of the differences.

The processor is further configured to determine a threshold value for the reconstruction error value to be a maximum value of the reconstruction error value or a three-sigma rule.

In accordance with another aspect of the disclosure, a failure diagnosis device for diagnosing an anomaly of equipment using a signal reconstruction model includes a memory configured to store instructions executable by a processor, and a processor, wherein the processor is configured to obtain a vibration frequency signal that measures vibration occurring in equipment through a vibration sensor, obtain a reconstructed signal corresponding to the vibration frequency signal from a trained signal reconstruction model by inputting the vibration frequency signal to the signal reconstruction model, determine a reconstruction error value representing a signal difference between the vibration frequency signal and the reconstructed signal for each predefined frequency band, and determine whether the equipment is abnormal based on the reconstruction error value determined for each frequency band and a threshold value determined for each frequency band.

The processor is further configured to, when at least one of the reconstruction error values determined for each frequency band is greater than the threshold value determined for each frequency band, determine that the equipment is abnormal.

The processor is further configured to, when all reconstruction error values determined for each frequency band are less than or equal to the threshold value determined for each frequency band, determine that the equipment is in a normal state.

The processor is further configured to determine the reconstruction error value based on at least one of an average of differences between an input signal and the reconstructed signal, an average of a square of the differences, and a square root of the average of the square of the differences.

The processor is further configured to, as a result of comparing the reconstruction error value determined for each frequency band with the threshold value determined for each frequency band, when a frequency band in which the reconstruction error value is greater than the threshold value is detected, estimate an anomaly type based on the detected frequency band.

In accordance with another aspect of the disclosure, a training method performed by a training device includes obtaining a vibration frequency signal that measures vibration occurring when equipment is normally operated through a vibration sensor, training a signal reconstruction model configured to generate a reconstructed signal corresponding to the vibration frequency signal based on the obtained vibration frequency signal, obtaining a reconstructed signal corresponding to the vibration frequency signal through the trained signal reconstruction model, determining a reconstruction error value representing a difference between the vibration frequency signal and the reconstructed signal, and determining a threshold value for the reconstruction error value for each of a plurality of predefined frequency bands.

The determining of the reconstruction error value includes determining the reconstruction error value based on one of an average of differences between the vibration frequency signal and the reconstructed signal, an average of a square of the differences, and a square root of the average of the square of the differences.

The determining of the threshold value includes determining a threshold value for the reconstruction error value to be a maximum value of the reconstruction error value or a three-sigma rule.

In accordance with another aspect of the disclosure, a failure diagnosis method performed by a failure diagnosis device for diagnosing an anomaly of equipment using a signal reconstruction model includes obtaining a vibration frequency signal that measures vibration occurring in equipment through a vibration sensor, obtaining a reconstructed signal corresponding to the vibration frequency signal from a trained signal reconstruction model by inputting the vibration frequency signal to the signal reconstruction model, determining a reconstruction error value representing a signal difference between the vibration frequency signal and the reconstructed signal for each predefined frequency band, and determining whether the equipment is abnormal based on reconstruction error values determined for each frequency band and a threshold value determined for each frequency band.

The determining of the anomaly includes, when at least one of the reconstruction error values determined for each frequency band is greater than the threshold value determined for each frequency band, estimating that the equipment is abnormal.

The failure diagnosis method further includes, when all reconstruction error values determined for each frequency band are less than or equal to the threshold value determined for each frequency band, determining that the equipment is in a normal state.

The signal reconstruction model includes at least one of an autoencoder, a stacked autoencoder, an LSTM autoencoder, and a convolutional autoencoder model.

The determining of the reconstruction error value includes determining the reconstruction error value based on an average of differences between an input signal and the reconstructed signal, an average of a square of the differences, and a square root of the average of the square of the differences.

The failure diagnosis method further includes, as a result of comparing the reconstruction error value determined for each frequency band with the threshold value determined for each frequency band, when a frequency band in which the reconstruction error value is greater than the threshold value is detected, estimate an anomaly type based on the detected frequency band.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating diagnosing a failure of equipment for each frequency band by a failure diagnosis device according to an embodiment;

FIG. 2 is a block diagram of components of a training device according to an embodiment;

FIG. 3 is a block diagram of components of a failure diagnosis device according to an embodiment;

FIG. 4 is a diagram illustrating determining a reconstruction error value using a signal reconstruction model according to an embodiment;

FIG. 5 is a diagram illustrating determining a reconstruction error value by changing a range of a frequency band according to an embodiment;

FIG. 6 is a diagram illustrating determining a reconstruction error value in a specific vibration frequency signal according to an embodiment;

FIG. 7 is a diagram illustrating determining a threshold value by a training device according to an embodiment;

FIG. 8 is a diagram illustrating determining a threshold value in a plurality of frequency bands by a training device according to an embodiment;

FIG. 9 is a diagram illustrating diagnosing a failure of equipment by a failure diagnosis device according to an embodiment;

FIG. 10 is a diagram illustrating estimating an anomaly type of equipment for each frequency band by a failure diagnosis device according to an embodiment;

FIG. 11 is a flowchart illustrating operations of a training method performed by a training device according to an embodiment;

FIG. 12 is a flowchart illustrating operations of a failure diagnosis method performed by a failure diagnosis device according to an embodiment;

FIG. 13 is a block diagram illustrating a training device according to an embodiment; and

FIG. 14 is a block diagram illustrating a failure diagnosis device according to an embodiment.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

The term “unit” used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the embodiments will be described in detail with reference to the accompanying drawings. When describing the embodiments with reference to the accompanying drawings, like reference numerals refer to like elements and a repeated description related thereto will be omitted.

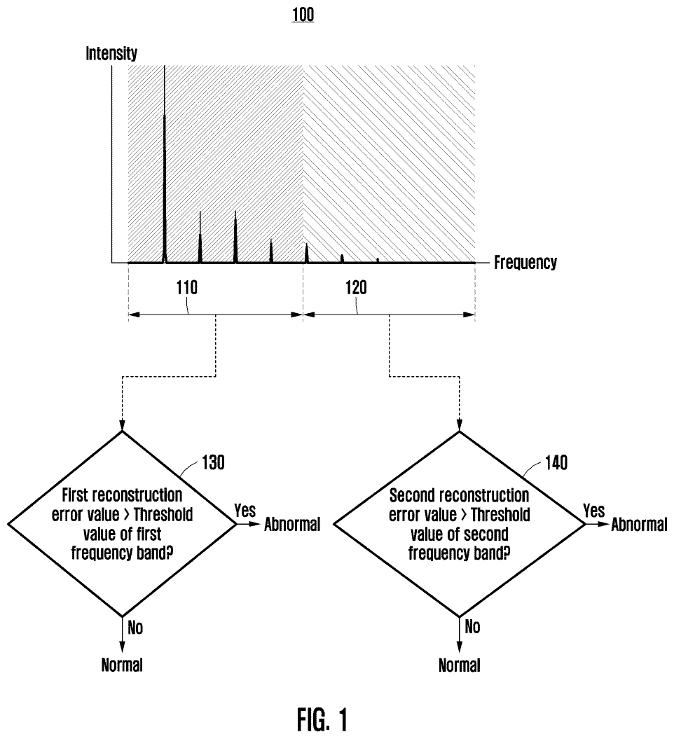

FIG. 1 is a diagram illustrating diagnosing a failure of equipment for each frequency band by a failure diagnosis device according to an embodiment.

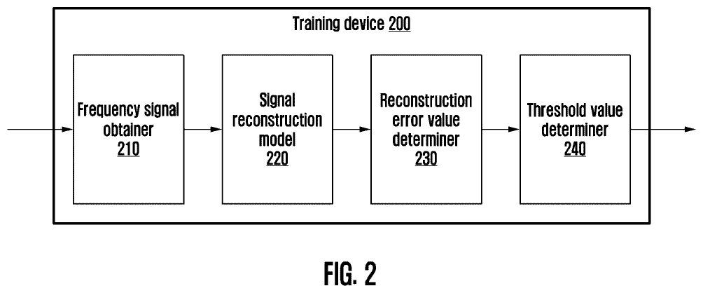

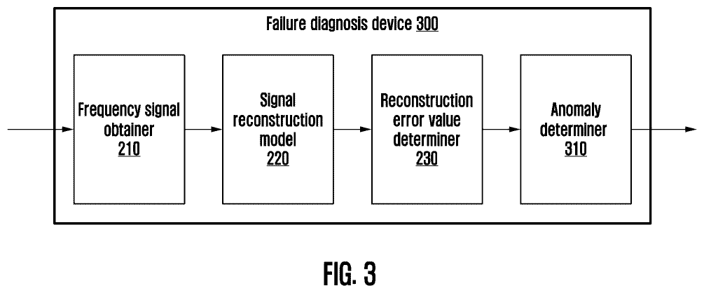

Referring to FIG. 1, a failure diagnosis device (e.g., a failure diagnosis device 300 of FIG. 3) may output a signal (hereinafter, referred to as a reconstructed signal) that is similar to an input frequency signal using a trained signal reconstruction model (e.g., a signal reconstruction model 220 of FIG. 2). The failure diagnosis device may diagnose a failure of equipment by comparing a predefined threshold with a difference (hereinafter, referred to as a reconstruction error) between the input frequency vibration signal and the reconstructed signal. The failure diagnosis device may diagnose a failure of equipment in a specific frequency domain, such as a low-frequency domain or a high-frequency domain, by comparing the reconstruction error with the threshold for each frequency band. The failure diagnosis device may diagnose the failure of equipment for each frequency band. The failure diagnosis device may diagnose the failure of equipment using the reconstruction error and a signal reconstructed by the signal reconstruction model in each frequency band. The number and range of divided frequency bands may vary depending on an operating environment of the equipment. The failure diagnosis device may diagnose the failure of equipment for each frequency band by comparing the reconstruction error with the predefined threshold for each frequency band. The failure diagnosis device may diagnose an anomaly for each frequency band and may diagnose the failure of equipment by performing an OR operation on an anomaly determination result of each frequency band. Since the failure diagnosis device determines an anomaly result for each frequency band, the failure diagnosis device may obtain information about the anomaly in a specific frequency band. In an embodiment, a graph 100 may illustrate a vibration frequency signal and a reconstructed signal of equipment. A frequency band of the graph 100 may be divided into a first frequency band 110 and a second frequency band 120. When a first reconstruction error value of the first frequency band 110 is greater than a threshold value of the first frequency band 110 (e.g., “Yes” in operation 130), the failure diagnosis device may diagnose that equipment related to the first frequency band 110 is abnormal, and when a second reconstruction error value is greater than a threshold value of the second frequency band 120 (e.g., “Yes” in operation 140), the failure diagnosis device may diagnose that equipment related to the second frequency band 120 is abnormal. When the failure diagnosis device diagnoses that equipment is abnormal in at least one of frequency bands, the failure diagnosis device may diagnose that the equipment fails. When the first reconstruction error value of the first frequency band 110 is less than the threshold value of the first frequency band 110 (e.g., “No” in operation 130) and the second reconstruction error value is less than the threshold value of the second frequency band 120 (e.g., “No” in operation 140), the failure diagnosis device may diagnose that the equipment is normal. The failure diagnosis device may determine that the equipment is normal when both anomaly diagnosis results in the first frequency band 110 and the second frequency band 120 are normal.

FIG. 2 is a block diagram of components of a training device according to an embodiment.

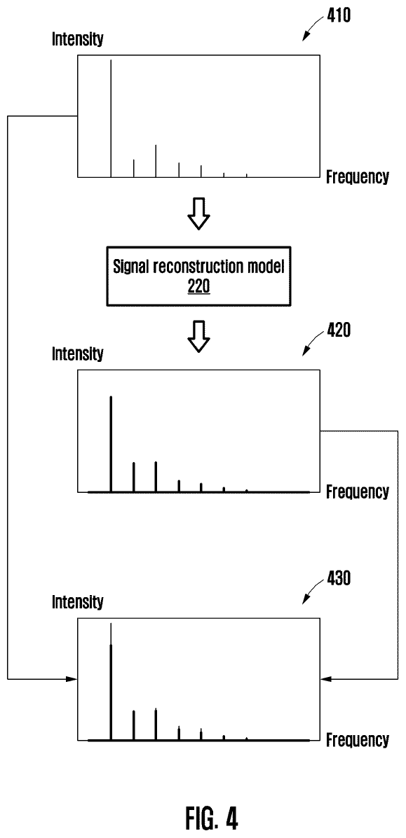

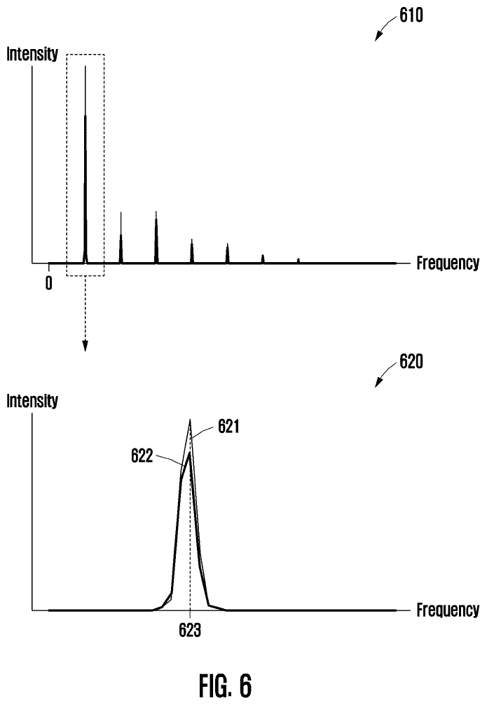

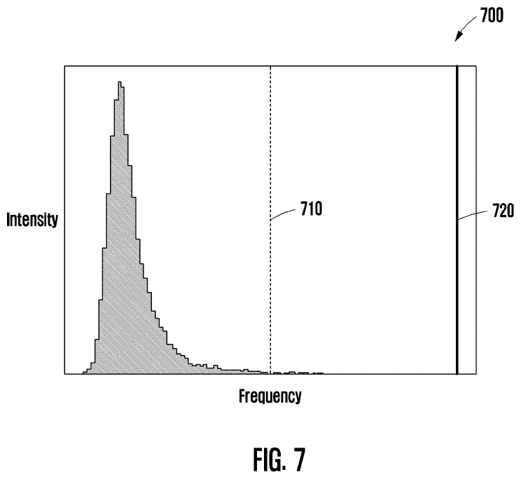

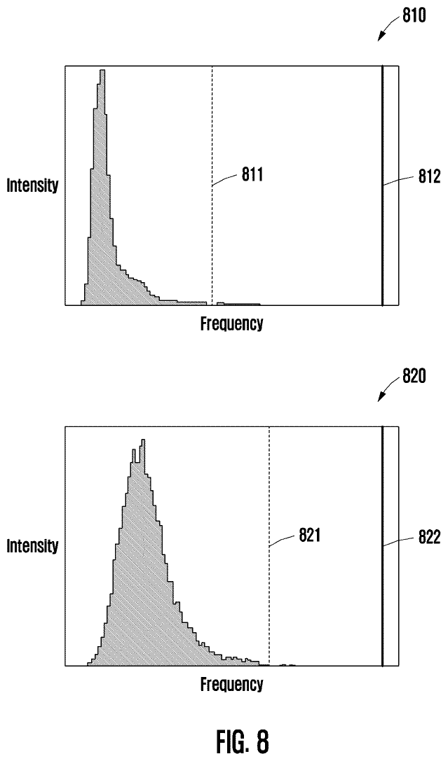

Referring to FIG. 2, a training device 200 may train a signal reconstruction model using a vibration frequency signal. The training device 200 may include a frequency signal obtainer 210, a signal reconstruction model 220, a reconstruction error value determiner 230, and a threshold value determiner 240. The frequency signal obtainer 210 may obtain a vibration frequency signal that measures vibration occurring when equipment is normally operated through a vibration sensor. For example, the training device 200 may obtain the vibration frequency signal in a state in which the equipment is normally operated using a vibration sensor in a micro-electromechanical system (MEMS) or integrated electronics piezo-electric (IEPE) type. A range of a frequency band of the obtained vibration frequency signal may vary depending on the specifications of the vibration sensor and an environment in which the vibration frequency signal is collected. The obtained vibration frequency signal may indicate an intensity according to a frequency on a graph. The signal reconstruction model 220 according to an embodiment may generate a reconstructed signal corresponding to the vibration frequency signal using the obtained vibration frequency signal. The training device 200 may obtain the reconstructed signal from the trained signal reconstruction model 220. The generation of a reconstructed signal by the signal reconstruction model 220 is further described with reference to FIG. 4. The reconstruction error value determiner 230 according to an embodiment may determine a reconstruction error value. The reconstruction error value may be a difference between a vibration frequency signal and a reconstructed signal. The determination of a reconstruction error value by the reconstruction error value determiner 230 is further described with reference to FIG. 6. The threshold value determiner 240 according to an embodiment may determine a threshold value for a reconstruction error value for each of a plurality of predefined frequency bands. The determination of a threshold value for an error value by the threshold value determiner 240 is further described with reference to FIGS. 7 and 8. The training device 200 may train (e.g., unsupervised learning) the signal reconstruction model 220 using vibration frequency signals (or vibration frequency data) of the facility in a normal state of operation. For example, the training device 200 may train the signal reconstruction model 220 to output a reconstruction signal having a reconstruction error value of the reconstruction signal less than a threshold value using vibration frequency signals of the facility in the normal state of operation obtained via the MEMS.

FIG. 3 is a block diagram of components of a failure diagnosis device according to an embodiment.

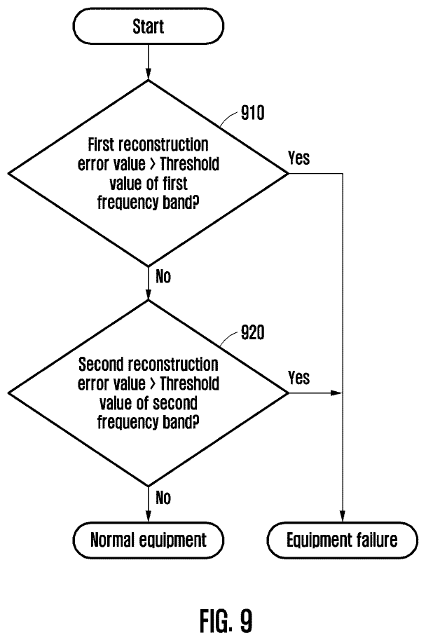

Referring to FIG. 3, a failure diagnosis device 300 may diagnose a failure of equipment using the signal reconstruction model 220. The failure diagnosis device 300 may include the frequency signal obtainer 210, the signal reconstruction model 220, the reconstruction error value determiner 230, and an anomaly determiner 310. The frequency signal obtainer 210, the signal reconstruction model 220, and the reconstruction error value determiner 230 may correspond to the frequency signal obtainer 210, the signal reconstruction model 220, and the reconstruction error value determiner 230 of FIG. 2, respectively, and descriptions thereof are omitted. The anomaly determiner 310 according to an embodiment may determine whether the equipment is abnormal. For example, the anomaly determiner 310 may determine whether the equipment is abnormal based on a reconstruction error value determined for each frequency band and a threshold value determined for each frequency band. When the anomaly determiner 310 diagnoses the anomaly for each frequency band, the anomaly determiner 310 may diagnose an anomaly in a portion of the equipment corresponding to a specific frequency band. The frequency band may vary depending on the vibration sensor and the operating environment of the equipment. The determination of anomaly of equipment by the anomaly determiner 310 is further described with reference to FIG. 9.

FIG. 4 is a diagram illustrating determining a reconstruction error value using a signal reconstruction model according to an embodiment.

Referring to FIG. 4, the signal reconstruction model 220 may generate a reconstructed signal 420 by receiving a vibration frequency signal 410. The reconstructed signal 420 is a signal generated by the signal reconstruction model 220 given the vibration frequency signal 410, representing a vibration signal similar to the vibration frequency signal 410. According to an embodiment, the signal reconstruction model 220 may generate the reconstructed signal 420 corresponding to each frequency domain. The reconstructed signal 420 corresponding to each frequency domain may be a signal generated by the signal reconstruction model 220 for each defined frequency domain where the vibration frequency signal 410 is input. The reconstructed signal 420 corresponding to each frequency domain may represent a vibration signal similar to the vibration frequency signal 410 in the defined frequency domain.

The signal reconstruction model 220 may include at least one of an autoencoder, a stacked autoencoder, a long short-term memory (LSTM) autoencoder, and a convolutional autoencoder model. The determination of a reconstruction error value using the signal reconstruction model 220 may be performed by a training device (e.g., the training device 200 of FIG. 2) and a failure diagnosis device (e.g., the failure diagnosis device 300 of FIG. 3). According to an embodiment, the training device may train the signal reconstruction model 220 using the vibration frequency signal 410 that occurs when the equipment is normally operated, and the trained signal reconstruction model 220 may generate the reconstructed signal 420 that is similar to the vibration frequency signal 410. A reconstruction error value determiner (e.g., the reconstruction error value determiner 230 of FIG. 2) included in the training device according to an embodiment may determine a difference between the vibration frequency signal 410 and the reconstructed signal 420 to be a reconstruction error 430. For example, for each frequency band, the training device may determine a difference 430 between a signal included in the vibration frequency signal 410 and a signal included in the reconstructed signal 420 to be a reconstruction error. According to an embodiment, a reconstruction error value determiner (e.g., the reconstruction error value determiner 230 of FIG. 3) included in the failure diagnosis device may input a vibration frequency signal (not shown) to the signal reconstruction model 220 and when the equipment is in operation, the signal reconstruction model 220 may generate a reconstructed signal (not shown) for an occurring vibration frequency signal (not shown). The failure diagnosis device may determine a signal (not shown) corresponding to the difference between the vibration frequency signal (not shown) and the reconstructed signal (not shown) to be a reconstruction error. The determination of a reconstruction error by the reconstruction error value determiner is further described with reference to FIG. 6.

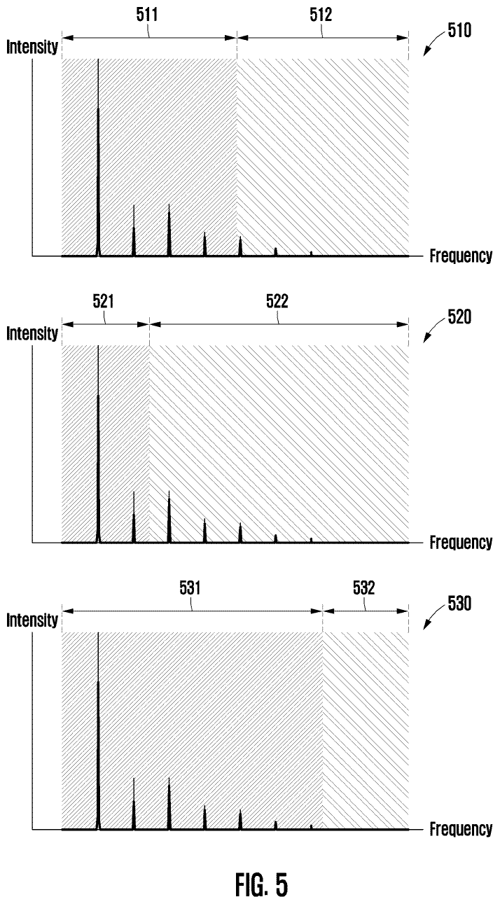

FIG. 5 is a diagram illustrating determining a reconstruction error value by changing a range of a frequency band according to an embodiment.

Referring to FIG. 5, a reconstruction error value determiner (e.g., the reconstruction error value determiner 230 of FIG. 2) included in a training device (e.g., the training device 200 of FIG. 2) or the failure diagnosis device (e.g., the failure diagnosis device 300 of FIG. 3) may determine a reconstruction error value by changing a range of a frequency band. The range of the frequency band according to an embodiment may vary depending on the vibration sensor and the environment in which the equipment is operated. For example, a graph 510 may include two frequency bands 511 and 512 having similar frequency band ranges. The reconstruction error value determiner may determine an error value for each vibration frequency signal included in the frequency band 511 and the frequency band 512. A graph 520 may include frequency bands 521 and 522. The frequency band 521 may include a vibration frequency signal with the greatest intensity among vibration frequency signals and a range of the frequency band may be less than the frequency band 522. A graph 530 may include frequency bands 531 and 532. The frequency band 531 may include most vibration frequency signals and a range of the frequency band may be greater than the frequency band 532.

FIG. 6 is a diagram illustrating determining a reconstruction error value in a specific vibration frequency signal according to an embodiment.

Referring to FIG. 6, a reconstruction error value determiner (e.g., the reconstruction error value determiner 230 of FIG. 2) may determine a reconstruction error value using a vibration frequency signal and a reconstructed signal. A graph 610 may indicate a vibration frequency signal for all frequency domains of measured vibration frequency signals. A graph 620 may be a graph that enlarges a vibration frequency signal with the greatest intensity. The reconstruction error value determiner according to an embodiment may determine a reconstruction error value based on an intensity of a vibration frequency signal 621 and an intensity of a reconstructed signal 622 in a frequency 623. For example, the reconstruction error value determiner may determine the reconstruction error value based on at least one of an average of differences between input signals and reconstructed signals, an average of squares of the differences, and a square root of the average of squares of the differences.

The determination of the reconstruction error value by the reconstruction error value determiner using the average of the differences between input vibration frequency signals and reconstructed signals may be expressed by Equation 1 below.

$$\frac{1}{n} {\sum }_{i = 1}^{n} \vert {X}_{i} - {X}_{i}^{′} \vert \qquad [ Equation 1 ]$$

The determination of the reconstruction error value by the reconstruction error value determiner using the average of squares of the differences between input vibration frequency signals and reconstructed signals may be expressed by Equation 2 below.

$$\frac{1}{n} {\sum }_{i = 1}^{n} {( {X}_{i} - {X}_{i}^{′} )}^{2} \qquad [ Equation 2 ]$$

The determination of the reconstruction error value by the reconstruction error value determiner using the average of a square root of the differences between input vibration frequency signals and reconstructed signals may be expressed by Equation 3 below.

$$\sqrt{\frac{{\sum }_{i = 1}^{n} {( {X}_{i} - {X}_{i}^{′} )}^{2}}{n}} \qquad [ Equation 3 ]$$

In Equations 1 to 3, n may be the number of signals, Xᵢ may be an intensity of an i-th vibration frequency signal, and X′ⁱ may be an intensity of an i-th reconstructed signal. FIG. 7 is a diagram illustrating determining a threshold value by a training device according to an embodiment.

Referring to FIG. 7, a threshold value determiner (e.g., the threshold value determiner 240 of FIG. 2) included in a training device (e.g., the training device 200 of FIG. 2) may determine a threshold value based on a distribution of reconstruction error values. A graph 700 may be a histogram representing intensities of reconstruction error values according to a frequency domain. The training device may obtain a threshold value using a reconstruction error distribution of vibration frequency signals of equipment that is normally operated. The threshold value determiner according to an embodiment may determine a threshold value for a reconstruction error value based on a maximum value 720 of the reconstruction error value or the three-sigma rule. For example, the threshold value determiner may determine the threshold value to be the maximum value 720 of the reconstruction error value or a value 710 that decreases from an average of the reconstruction error values by three times the standard deviation of the reconstruction error values.

FIG. 8 is a diagram illustrating determining a threshold value in a plurality of frequency bands by a training device according to an embodiment.

Referring to FIG. 8, a threshold value determiner (e.g., the threshold value determiner 240 of FIG. 2) included a training device (e.g., the training device 200 of FIG. 2) may determine a threshold value for each frequency band (e.g., each of N frequency bands). For example, a graph 810 may represent a reconstruction error value in a first frequency band. The threshold value determiner may determine a first threshold value to be a maximum value 812 of reconstruction error value for the first frequency band or a value 811 that decreases from an average of the reconstruction error values by three times the standard deviation of the reconstruction error values. A graph 820 may represent a reconstruction error value in a second frequency band. The threshold value determiner may determine a second threshold value to be a maximum value 822 of reconstruction error value for the second frequency band or a value 821 that decreases from an average of the reconstruction error values by three times the standard deviation of the reconstruction error values.

FIG. 9 is a diagram illustrating diagnosing a failure of equipment by a failure diagnosis device according to an embodiment.

Referring to FIG. 9, a failure diagnosis device (e.g., the failure diagnosis device 300 of FIG. 3) may diagnose a failure of equipment by diagnosing an anomaly of the equipment for each frequency band. When there is no anomaly in all frequency domains, the failure diagnosis device may determine that the equipment is in a normal state. In an embodiment, the failure diagnosis device may determine that the equipment is abnormal when at least one of reconstruction error values determined for each frequency band is greater than a threshold value determined for each frequency band. For example, when a first reconstruction error value is greater than a threshold value of a first frequency band (e.g., “Yes” in operation 910) or a second reconstruction error value is greater than a threshold value of a second frequency band (e.g., “Yes” in operation 920), the failure diagnosis device may determine that the equipment is abnormal. In an embodiment, the failure diagnosis device may determine that the equipment is in a normal state when all reconstruction error values determined for each frequency band are less than or equal to threshold values determined for each frequency band. For example, when the first reconstruction error value is less than or equal to the threshold value of the first frequency band (e.g., “No” in operation 910) and the second reconstruction error value is less than or equal to the threshold value of the second frequency band (e.g., “No” in operation 920), the failure diagnosis device may determine that the equipment is in the normal state.

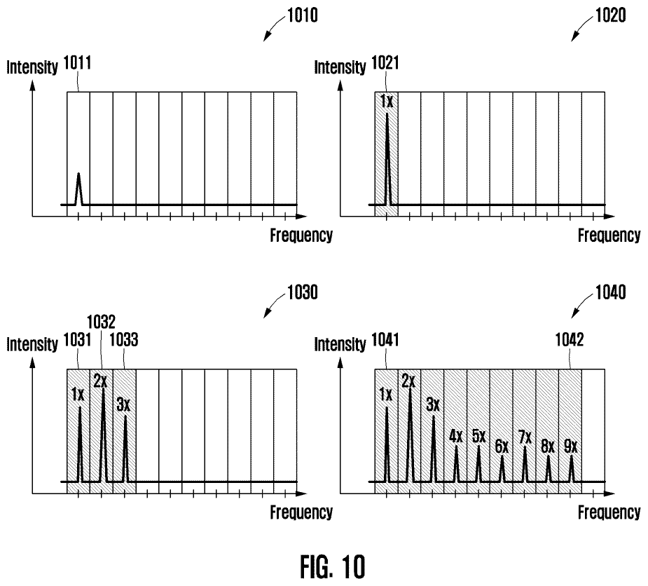

FIG. 10 is a diagram illustrating estimating an anomaly type of equipment for each frequency band by a failure diagnosis device according to an embodiment.

Referring to FIG. 10, a failure diagnosis device (e.g., the failure diagnosis device 300 of FIG. 3) may compare a reconstruction error value determined for each frequency band with a threshold value determined for each frequency band. When a frequency band in which the reconstruction error value is greater than the threshold value is detected as a result of comparing the reconstruction error value with the threshold value, the failure diagnosis device may estimate an anomaly type based on the detected frequency band. When a reconstruction error value is less than or equal to a threshold value in a frequency band 1011 of a graph 1010, and a vibration frequency signal is not detected in a different frequency band, the failure diagnosis device may determine that the equipment is in a normal state. When a reconstruction error value is greater than a threshold value in a frequency band 1021 of a graph 1020, the failure diagnosis device may estimate the anomaly type (e.g., 1× type) of the equipment related to the frequency band 1021. When a reconstruction error value is greater than the threshold value in each of frequency bands 1031, 1032, and 1033 of a graph 1030, the failure diagnosis device may estimate the anomaly type (e.g., 1× type, 2× type, or 3× type) of the equipment related to the frequency bands 1031, 1032, and 1033. When reconstruction error values respectively corresponding to frequency bands 1041 and 1042 of a graph 1040 are greater than the threshold value, the failure diagnosis device may estimate the anomaly type (e.g., 1× type, 2× type, 3× type, 4× type, 5× type, 6× type, 7× type, 8× type, or 9× type) of the equipment related to each frequency band.

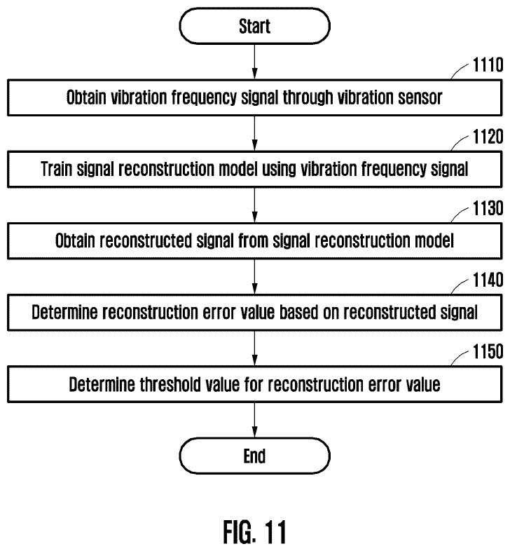

FIG. 11 is a flowchart illustrating operations of a training method performed by a training device according to an embodiment. The training method may be performed by a training device (e.g., the training device 200 of FIG. 2). In operation 1110, the training device may obtain a vibration frequency signal through a vibration sensor. The training device may obtain a vibration frequency signal that measures vibration that occurs when the equipment is normally operated through the vibration sensor. For example, the training device may obtain the vibration frequency signal from the equipment using the vibration sensor, such as a MEMS or IEPE type. In operation 1120, the training device may train the signal reconstruction model using the vibration frequency signal. The training device may train a signal reconstruction model that generates a reconstructed signal corresponding to the vibration frequency signal based on the obtained vibration frequency signal. The signal reconstruction model may include at least one of an autoencoder, a stacked autoencoder, a long short-term memory (LSTM) autoencoder, and a convolutional autoencoder model. In operation 1130, the training device may obtain the reconstructed signal from the signal reconstruction model. The trained signal reconstruction model may generate and output a reconstructed signal that is a similar signal to the vibration frequency signal based on the input vibration frequency signal. The training device may obtain the reconstructed signal corresponding to a frequency signal. In operation 1140, the training device may determine a reconstruction error value based on the reconstructed signal. The training device may determine a reconstruction error value that represents a difference between the vibration frequency signal and the reconstructed signal. For example, the training device may determine the reconstruction error value based on one of an average of differences between vibration frequency signal and reconstructed signals, an average of squares of the differences, and a square root of the average of squares of the differences. In operation 1150, the training device may determine a threshold value for the reconstruction error value. The training device may determine the threshold value for the reconstruction error value for each of a plurality of predefined frequency bands. For example, the training device may determine the threshold value to be a maximum value of the reconstruction error value or a value that decreases from an average of the reconstruction error values by three times of a standard deviation of the reconstruction error values using the three-sigma rule.

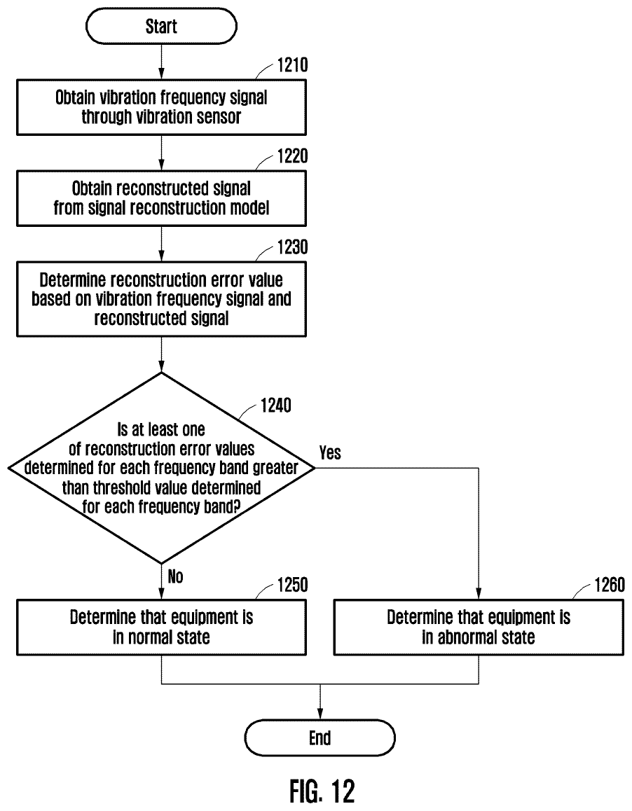

FIG. 12 is a flowchart illustrating operations of a failure diagnosis method performed by a failure diagnosis device according to an embodiment. Operations of the failure diagnosis method may be performed by a failure diagnosis device (e.g., the failure diagnosis device 300 of FIG. 3) that diagnoses an anomaly of equipment using a signal reconstruction model. In operation 1210, the failure diagnosis device may obtain a frequency signal through a vibration sensor. For example, the failure diagnosis device may obtain a vibration frequency signal that measures vibration occurring while the equipment is operated through the vibration sensor, such as the MEMS or IEPE type. In operation 1220, the failure diagnosis device may obtain a reconstructed signal from a signal reconstruction model. The failure diagnosis device may obtain the reconstructed signal corresponding to a vibration frequency signal by inputting the vibration frequency signal to the trained signal reconstruction model. For example, the failure diagnosis device may obtain the reconstructed signal from the signal reconstruction model including at least one of an autoencoder, a stacked autoencoder, an LSTM autoencoder, and a convolutional autoencoder model. In operation 1230, the failure diagnosis device may determine the reconstruction error value based on the vibration frequency signal and the reconstructed signal. The failure diagnosis device may determine a reconstruction error value representing a difference between a vibration frequency band signal and a reconstructed signal for each predefined frequency band. For example, for each frequency band, the failure diagnosis device may determine the reconstruction error value based on an average of differences between input signals and reconstructed signals, an average of squares of the differences, and a square root of the average of squares of the differences. In an embodiment, when at least one of reconstruction error values determined for each frequency band is not greater than a threshold value determined for each frequency band (e.g., “No” in operation 1240), the failure diagnosis device may determine 1250 that the equipment is in a normal state. For example, the failure diagnosis device may determine that the equipment is in a normal state when all reconstruction error values determined for each frequency band are less than or equal to threshold values determined for each frequency band. In an embodiment, when at least one of reconstruction error values determined for each frequency band is greater than a threshold value determined for each frequency band (e.g., “Yes” in operation 1240), the failure diagnosis device may determine 1250 that the equipment is in an abnormal state. In an embodiment, the failure diagnosis device may determine whether the equipment is abnormal based on the reconstruction error value determined for each frequency band and the threshold value determined for each frequency band. For example, when a frequency band in which the reconstruction error value is greater than the threshold value is detected as a result of comparing the reconstruction error value determined for each frequency band with the threshold value determined for each frequency band, the failure diagnosis device may estimate an anomaly type based on the detected frequency band. The failure diagnosis device may detect an equipment anomaly, such as unbalance, misalignment, bearing faults, and looseness of the equipment, based on the detected frequency band. The failure diagnosis device may estimate an anomaly type of the equipment by performing anomaly detection of the equipment for each frequency band using the vibration frequency signal. Since the vibration frequency signal occurring in the equipment indicates high amplitude in a specific frequency domain depending on the fault type, the failure diagnosis defect may estimate the anomaly type of the equipment using the vibration frequency signal.

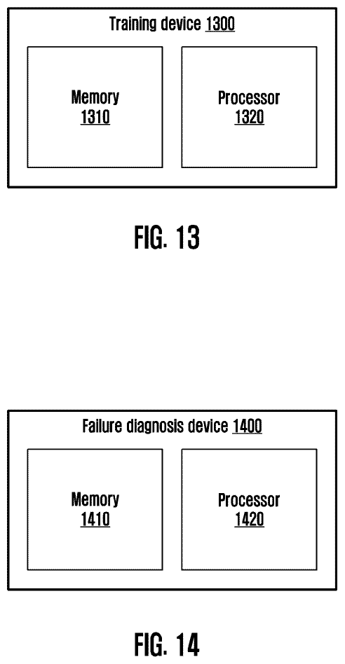

FIG. 13 is a block diagram illustrating a training device according to an embodiment. Referring to FIG. 13, a training device 1300 may include a memory 1310 and a processor 1320. The training device 1300 may correspond to the training device 200 of FIG. 2. Operations of the frequency signal obtainer 210, the signal reconstruction model 220, the reconstruction error value determiner 230, and the threshold value determiner 240 of FIG. 2 may be performed by the processor 1320.

The memory 1310 may store instructions that the processor 1320 may perform. The memory 1310 may store instructions executable by the processor 1320. When executed by the processor 1320, the instructions executable by the processor 1320 may cause the processor 1320 to perform the training method of the signal reconstruction model 220. The memory 1310 may be integrated with the processor 1320. For example, random-access memory (RAM) or flash memory may be arranged in an integrated circuit (IC) microprocessor. In addition, the memory 1310 may include a separate device, such as an external disk drive, a storage array, or other storage devices that may be used by a database system. The memory 1310 and the processor 1320 may be operatively integrated or may allow the processor 1320 to read a file stored in the memory 1310 by communicating with each other via an I/O port or a network connection. The memory 1310 may be a non-transitory computer-readable storage medium that stores instructions and when the instructions are executed by the processor 1320, the instructions stored in the memory 1310 may prompt at least one processor 1320 to execute a training method of a training device.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, hard disk drive (HDD), solid-state drive (SSD), card memory (e.g., a multimedia card, a secure digital (SD) card, or an extreme digital (XD) card), magnetic tape, floppy disk, a magneto-optical data storage device, an optical data storage device, and other devices.

For example, the processor 1320 may execute the instructions stored in the memory 1310. The processor 1320 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof.

The processor 1320 may train a signal reconstruction model that obtains a vibration frequency signal that measures vibration occurring when the equipment is normally operated through a vibration sensor and generates a reconstructed signal corresponding to the vibration frequency signal based on the obtained vibration frequency signal. The processor 1320 may obtain a reconstructed signal corresponding to the vibration frequency signal through the trained signal reconstruction model, may determine a reconstruction error value representing a difference between the vibration frequency signal and the reconstructed signal, and may determine a through value for the reconstruction error value for each of a plurality of predefined frequency bands.

For example, the processor 1320 may determine the reconstruction error value based on one of an average of differences between vibration frequency signal and reconstructed signals, an average of squares of the differences, and a square root of the average of squares of the differences and may determine the threshold value for the reconstruction error value based on the maximum value of the reconstruction error value or the three-sigma rule.

FIG. 14 is a block diagram illustrating a failure diagnosis device according to an embodiment.

Referring to FIG. 14, a failure diagnosis device 1400 may include a memory 1410 and a processor 1420. The failure diagnosis device 1400 may correspond to the failure diagnosis device 300 of FIG. 3. Operations of the frequency signal obtainer 210, the signal reconstruction model 220, the reconstruction error value determiner 230, and the anomaly determiner 310 FIG. 3 may be performed by the processor 1420.

The memory 1410 may store instructions that the processor 1420 may perform. The memory 1410 may store instructions executable by the processor 1420. When the instructions executable by the processor 1420 are executed by the processor 1420, the memory 1410 may be integrated with the processor 1420. For example, random-access memory (RAM) or flash memory may be arranged in an integrated circuit (IC) microprocessor. In addition, the memory 1410 may include a separate device, such as a storage device that may be used by an external disk drive, a storage array, or a database system. The memory 1410 and the processor 1420 may be operatively integrated or may allow the processor 1420 to read a file stored in the memory 1410 by communicating with each other via an I/O port or a network connection.

The memory 1410 may be a non-transitory computer-readable storage medium that stores instructions and when the instructions are executed by the processor 1420, the instructions stored in the memory 1410 may prompt at least one processor 1420 to execute the failure diagnosis device 1400.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, hard disk drive (HDD), solid-state drive (SSD), card memory (e.g., a multimedia card, a secure digital (SD) card, or an extreme digital (XD) card), magnetic tape, floppy disk, a magneto-optical data storage device, an optical data storage device, and other devices.

For example, the processor 1420 may execute the instructions stored in the memory 1410. The processor 1420 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof.

The processor 1420 may obtain a vibration frequency signal that measures vibration occurring in the equipment through a vibration sensor and may obtain a reconstructed signal corresponding to the vibration frequency signal from the signal reconstruction model by inputting the vibration frequency signal to the trained signal reconstruction model. The processor 1420 may determine a reconstruction error value representing a difference between the vibration frequency signal and the reconstructed signal for each predefined frequency band and may determine whether the equipment is abnormal based on the reconstruction error value determined for each frequency band and a threshold value determined for each frequency band.

The processor 1420 may determine that the equipment is abnormal when at least one of reconstruction error values determined for each frequency band is greater than a threshold value determined for each frequency band and when all reconstruction error values determined for each frequency band are less than or equal to the threshold value determined for each frequency band, the processor 1420 may determine that the equipment is in the normal state.

For example, the processor 1420 may determine the reconstruction error value based on at least one of an average of differences between input signals and reconstructed signals, an average of squares of the differences, and a square root of the average of squares of the differences.

When a frequency band in which the reconstruction error value is greater than the threshold value is detected as a result of comparing the reconstruction error value determined for each frequency band with the threshold value determined for each frequency band, the processor 1420 may estimate an anomaly type based on the detected frequency band.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or pseudo equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other examples, and equivalents to the claims are also within the scope of the following claims.

What is claimed is:

1. A training device comprising:
a memory configured to store instructions executable by a processor; and
a processor,
wherein the processor is configured to:
obtain a vibration frequency signal that measures vibration occurring when equipment is normally operated through a vibration sensor,
train a signal reconstruction model configured to generate a reconstructed signal corresponding to the vibration frequency signal based on the obtained vibration frequency signal,
obtain a reconstructed signal corresponding to the vibration frequency signal through the trained signal reconstruction model,
determine a reconstruction error value representing a difference between the vibration frequency signal and the reconstructed signal, and
determine a threshold value for the reconstruction error value for each of a plurality of predefined frequency bands.

2. The training device of claim 1, wherein the signal reconstruction model comprises at least one of an autoencoder, a stacked autoencoder, a long short-term memory (LSTM) autoencoder, and a convolutional autoencoder model.

3. The training device of claim 1, wherein the processor is further configured to determine the reconstruction error value based on at least one of an average of differences between the vibration frequency signal and the reconstructed signal, an average of a square of the differences, and a square root of the average of the square of the differences.

4. The training device of claim 1, wherein the processor is further configured to determine a threshold value for the reconstruction error value to be a maximum value of the reconstruction error value or a three-sigma rule.

5. A failure diagnosis device for diagnosing an anomaly of equipment using a signal reconstruction model, the failure diagnosis device comprising:
a memory configured to store instructions executable by a processor; and
a processor,
wherein the processor is configured to:
obtain a vibration frequency signal that measures vibration occurring in equipment through a vibration sensor,
obtain a reconstructed signal corresponding to the vibration frequency signal from a trained signal reconstruction model by inputting the vibration frequency signal to the signal reconstruction model,
determine a reconstruction error value representing a signal difference between the vibration frequency signal and the reconstructed signal for each predefined frequency band, and
determine whether the equipment is abnormal based on the reconstruction error value determined for each frequency band and a threshold value determined for each frequency band.

6. The failure diagnosis device of claim 5, wherein the processor is further configured to, when at least one of the reconstruction error values determined for each frequency band is greater than the threshold value determined for each frequency band, determine that the equipment is abnormal.

7. The failure diagnosis device of claim 5, wherein the processor is further configured to, when all reconstruction error values determined for each frequency band are less than or equal to the threshold value determined for each frequency band, determine that the equipment is in a normal state.

8. The failure diagnosis device of claim 5, wherein the signal reconstruction model comprises at least one of an autoencoder, a stacked autoencoder, a long short-term memory (LSTM) autoencoder, and a convolutional autoencoder model.

9. The failure diagnosis device of claim 5, wherein the processor is further configured to determine the reconstruction error value based on at least one of an average of differences between an input signal and the reconstructed signal, an average of a square of the differences, and a square root of the average of the square of the differences.

10. The failure diagnosis device of claim 5, wherein the processor is further configured to, as a result of comparing the reconstruction error value determined for each frequency band with the threshold value determined for each frequency band, when a frequency band in which the reconstruction error value is greater than the threshold value is detected, estimate an anomaly type based on the detected frequency band.

11. A failure diagnosis method performed by a failure diagnosis device for diagnosing an anomaly of equipment using a signal reconstruction model, the failure diagnosis method comprising:
obtaining a vibration frequency signal that measures vibration occurring in equipment through a vibration sensor;
obtaining a reconstructed signal corresponding to the vibration frequency signal from a trained signal reconstruction model by inputting the vibration frequency signal to the signal reconstruction model;
determining a reconstruction error value representing a signal difference between the vibration frequency signal and the reconstructed signal for each predefined frequency band; and
determining whether the equipment is abnormal based on reconstruction error values determined for each frequency band and a threshold value determined for each frequency band.

12. The failure diagnosis method of claim 11, wherein the determining of the anomaly comprises:
when at least one of the reconstruction error values determined for each frequency band is greater than the threshold value determined for each frequency band, estimating that the equipment is abnormal.

13. The failure diagnosis method of claim 11, further comprising:
when all reconstruction error values determined for each frequency band are less than or equal to the threshold value determined for each frequency band, determining that the equipment is in a normal state.

14. The failure diagnosis method of claim 11, wherein the signal reconstruction model comprises at least one of an autoencoder, a stacked autoencoder, a long short-term memory (LSTM) autoencoder, and a convolutional autoencoder model.

15. The failure diagnosis method of claim 11, wherein the determining of the reconstruction error value comprises:
determining the reconstruction error value based on an average of differences between an input signal and the reconstructed signal, an average of a square of the differences, and a square root of the average of the square of the differences.

16. The failure diagnosis method of claim 11, further comprising:
as a result of comparing the reconstruction error value determined for each frequency band with the threshold value determined for each frequency band, when a frequency band in which the reconstruction error value is greater than the threshold value is detected, estimate an anomaly type based on the detected frequency band.

17. The failure diagnosis method of claim 11, wherein the signal reconstruction model is trained by:
obtaining a vibration frequency signal that measures vibration occurring when equipment is normally operated through a vibration sensor;
training the signal reconstruction model configured to generate a reconstructed signal corresponding to the vibration frequency signal based on the obtained vibration frequency signal;
obtaining a reconstructed signal corresponding to the vibration frequency signal through the trained signal reconstruction model;
determining a reconstruction error value representing a difference between the vibration frequency signal and the reconstructed signal; and
determining a threshold value for the reconstruction error value for each of a plurality of predefined frequency bands.

18. The failure diagnosis method of claim 17, wherein the determining of the reconstruction error value comprises:
determining the reconstruction error value based on one of an average of differences between the vibration frequency signal and the reconstructed signal, an average of a square of the differences, and a square root of the average of the square of the differences.

19. The failure diagnosis method of claim 17, wherein the determining of the threshold value comprises:
determining a threshold value for the reconstruction error value to be a maximum value of the reconstruction error value or a three-sigma rule.
